(19) United States
(12) Patent Application Publication
(10) Pub. No.: US 2001/0032191 A1
(43) Pub. Date: Oct. 18, 2001

(54) Electronic settlement payment method

(76) Inventors: Key-Sun Choi, Taejon (KR); Kyoung-Whan Choe, Taejon (KR)

Correspondence Address: BACON & THOMAS, PLLC, 625 Slaters Lane - 4th Floor, Alexandria, VA, 22314-1176, US

(21) Appl. No.: 09/729,107

(22) Filed: Dec. 5, 2000

(30) Foreign Application Priority Data
Apr. 17, 2000 (KR) 20136

(51) Int. Cl. G06F 17/60

(52) U.S. Cl. 705/64

(57) ABSTRACT

Disclosed is a method of paying an electronic settlement in an electronic commerce by assigning a payment settlement agency between a payer and a payee. The method includes a first step of the payer obtaining an electronic catalog from the payee through Internet; a second step of the payer approving an access of a payer's bank account by a payment settlement agency server; a third step of the payer ordering goods to a payee server and paying a settlement through of the payment settlement agency; a fourth step of the payment settlement agency server providing confirmation of an effect of transaction between the payer and the payee to concerned parties of the transaction; and a fifth step of transferring a deposit from the payer's bank account to a payee's bank account through a financial network.

### BACKGROUND OF THE INVENTION

1. Field of the Invention

The present invention relates to a method of paying an electronic settlement in an electronic commerce, and more particularly to a method of paying an electronic settlement in an electronic commerce by assigning a payment settlement agency (single or plural agencies mediating a business transaction) between a payer (a subject that pays a currency value; called as a client) and a payee (a subject that receives the currency value; called as a store).

2. Description of the Related Art

Conventionally, the electronic settlement payment has been effected using a payment protocol. As the payment protocol, there exist a Milicent protocol; a small-sum settlement system including an electronic coin type whose representative is PayWord, a network type whose representative are an Ecash system and a Netcash system, and an IC type called as a Mondex system; a credit card based payment settlement system whose representative is a SET system; and an electronic money transfer which is one of the Internet banking services. Hereinafter, several electronic settlement systems will be explained with reference to FIG. 1.

FIG. 1 is a view illustrating a conventional process of an electronic settlement payment. Referring to FIG. 1, the process includes a first step of a payer transferring an order information and a payment information to a payee, a second step of the payee transferring the payment information to a payment settlement agency, a third step of the payment settlement agency paying a currency value to the payee, and a fourth step of the payee delivering ordered goods to the payer.

In cases of the Milicent, Ecash, Netcash, or PayWord system conventionally used, the electronic coin transferred from the payer to the payee is regarded as cash. Accordingly, the anonymity of the business is secured by only the payee's confirmation of the validity of the electronic coin.

However, the use of the electronic coin used in the Milicent system is limited to particular stores, and thus the general use thereof is somewhat troublesome. The Ecash secures the absolute anonymity of the business, but it is very difficult to prevent the double use of the electronic coin.

In addition, the Netcash secures the restricted anonymity and can be expanded widely. The Netcash neglects the security to short a dealing time. In the PayWord, since the electronic coin paid to the store has an information on the payer's identity, the anonymity of the payer is not secured.

In the SET system, the information transferred from the payer to the payee is one transferred to the payment settlement agency. Such an information is accessed only by the payment settlement agency, and comprises a sensitive information such as the credit card number of the client. Accordingly, other persons or agencies including the payee cannot access to the business information of the payer. Since the payee has the identity of the payer, however, the anonymity of the business is not secured. In addition, since the cost of confirming the validity of the payment information at the settlement agency is excessive, it is not suitable for the small-sum payment.

Also, the IC card type electronic currency system secures the anonymity of business, and is suitable for the small-sum payment. Since the cost of the initial provision to manage the system is too much, the system is rarely used.

An electronic money transfer using the Internet banking service is one of the payment methods, whereby the order for goods and the payment therefor are separately performed. Specifically, a client gives an order for goods at a store, and pays directly the settlement therefor using the electronic money transfer through a bank. According to this method, there is no danger to the disclosure of the settlement information to the payee, but the order and the payment cannot be performed in one process, thereby being contrary to the electronic commerce searching for the convenience of the client.

The above methods are based on the protocol that enables the order and the payment to be effected through the communication between the payer and the payee. When the payer and the payee have a deal through a network without meeting with each other, it is necessary to confirm the identity of the counterparts so as to secure the business. This confirmation process is carried out by a computer, so that the result thereof is recorded. Therefore, it is natural that it is difficult to secure the anonymity of the business, so that the privacy of the client may be disclosed in the electronic commerce.

### SUMMARY OF THE INVENTION

Therefore, an object of the present invention is to provide a method of paying an electronic settlement in an electronic commerce by assigning a payment settlement agency between a payer and a payee to prevent the private information from being disclosed, thereby securing the anonymity.

Another object of the present invention is to provide a method of improving the confidence of business, whereby a payee has a deal with a payment settlement agency having a clear identity on behalf of a payer having an unclear identity.

Still another object of the present invention is to provide a method of maintaining the business particulars of a payer in secret.

In accordance with the present invention, to achieve the above objects, there is provided a method of paying an electronic settlement in an electronic commerce by assigning a payment settlement agency between a payer and a payee to prevent the private information from being disclosed, the method comprising a first step of the payer obtaining an electronic catalog from the payee through Internet; a second step of the payer approving an access of a payer's bank account by a payment settlement agency server; a third step of the payer ordering goods to a payee server and paying a settlement through of the payment settlement agency; a fourth step of the payment settlement agency server providing confirmation of an effect of transaction between the payer and the payee to concerned parties of the transaction; and a fifth step of transferring a deposit from the payer's bank account to a payee's bank account through a financial network.

### BRIEF DESCRIPTION OF THE DRAWINGS

The above objects, other features and advantages of the present invention will become more apparent after a reading of the following detailed description when taken in conjunction with the drawings, in which:

FIG. 1 is a view illustrating a conventional process of an electronic settlement; and

FIG. 2 is a view illustrating a process of an electronic settlement payment according to a preferred embodiment of the present invention.

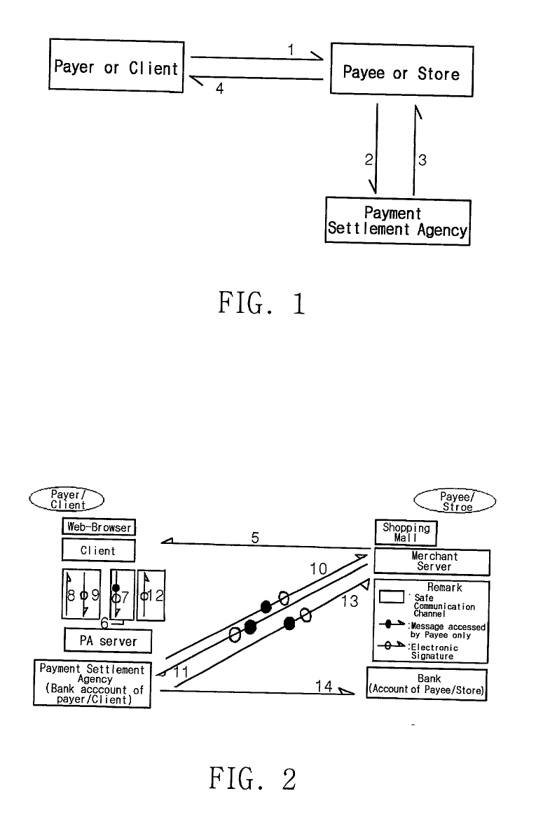

### DETAILED DESCRIPTION OF THE PREFERRED EMBODIMENT

FIG. 2 is a view illustrating a process of an electronic settlement payment according to a preferred embodiment of the present invention. In FIG. 2, a reference numeral 5 denotes a first step of a payment process in which a payer obtains an electronic catalog from a payee. Since the first step is carried out in an anonymity in case that the payer requests, the payee transfers the catalog without requesting an identity information of the payer, but requires a restricted private information of the payer under an agreement of the payer. The first step (step 5) demands a catalog of the payer, but this step is not essential.

Contents of the catalog to be transferred are as follows:

1. Classification code of goods (for example, an identifying code of goods);

2. Price of the goods;

3. Business information of the payee (for example, an account number of the payee);

4. Connection information of the payee (the place to which the payment settlement agency sends the information);

5. Certification of the payee;

6. Position of the up-to-date information; and

7. Signature of the payee for all the above terms.

The player determines the validity of the catalog in view of the information included in the catalog, and this can be automatically performed by a program without intervention of the user.

The payment settlement agency is one or more organization meeting following requirements: the agency must have a bank account of the client, can transfer a deposit from the client according to the demand of the client, and must certify the deal particulars.

A next step allows the payer to use its own bank account in the payment settlement agency.

Specifically, the payer connects to the payment settlement agency (step 6), and then sends an information to the payment settlement agency to confirm the identity of the payer (step 7). The information is electronically executed by the payer, and is coded by a key of the payment settlement agency. Accordingly, only the payment settlement agency can access to the identity information of the payer, and can recognize the connection request of the payer by confirming the signature of the payer. After the step, the payer can access to his/her own account in the payment settlement agency.

And then, the payer orders the payee goods and pays the money through the payment settlement agency. Specifically, the payment settlement agency gives a business number to the payer (step 8). Referring to the catalog received from the payment settlement agency, the payer sends to the payment settlement agency the business number and the coded information, which includes the order, payment amount, and information on the payee and is accessed by the payee only (step 9). Referring to the information on the payee in the coded information, the payment settlement agency sends to the payee the business number, information of the payment settlement information, and order information (step 10). The above information is coded so that only the payee can access it. If the payee receives the above information from the payment settlement agency, he/she checks the order, and sends to the payment settlement agency the price of the good along with the business number (step 11).

The business number is shared among the payer, the payment settlement agency, and the payee. If necessary, the business particulars may be traced based on the business number. Because the business number is coded, the other person cannot recognize it in any case.

The information at the step 9 includes a classification code of the ordered good, position to be delivered, random numbers for preventing the order information from being traced by the payment settlement agency, and information including store business information, store connection information, and a store certification.

Since the information of step 10 is transferred from the payment settlement agency to the payee through an open network, i.e., Internet, the information is coded and executed to be accessed only by the payee to prevent the wiretapping and forgery by other persons. The information of the payment settlement agency includes the connection information of the payment settlement agency and a certification of the payment settlement agency.

Then, the payment settlement agency confirms the effect of transaction between the payer and the payee.

Specifically, the payment settlement agency compares the price of goods received from the payee with the price of goods ordered by the payer to confirm the exact transfer of the order information. After the confirmation, the payment settlement agency declares the business effect to both payer and payee. The payment settlement agency certifies and sends to the payer the information that is received from the payer at step 9 (step 12), and certifies and sends to the payee the information along with the business number and an amount of money to be paid (step 13). In this case, the information to be sent to the payee is coded so as to be accessed only by the payee.

The information received at step 12 serves as a receipt of the bought goods, and the information received at step 13 serves as a check that should be paid by the payer.

Finally, after the completion of payment, the currency value is transferred to settle accounts (step 14). The step 14 is achieved through an existing financial network, so that the determined amount is transferred from the account of the payer to the account of the payee. At that time, the business number is also transferred to complete the interest business.

Referring to FIG. 2, the payee, the payee and the payment settlement agency use different program, respectively, for example a client, a merchant server, and a payment authority server. The client confirms the validity of the catalog, produces the order information, and saves the business particulars. The merchant server examines the total stock of goods, adjusts and saves the orders, and produces a response information regarding the order. And, the payment authority server carries out the transfer work in connection with the financial network, and confirms the order of the client and the business particulars.

Other embodiments of the present invention will now be explained.

The first case is that the user takes an electronic commerce using a personal computer at home. The payer A connects to an electronic commerce site using a web-browser, and brings the catalog of wanted goods. At that time, the payer connects to a catalog file by clicking a button of ‘BUY’ on a homepage, and the web-browser executes automatically an electronic settlement payment plug-in. The electronic settlement payment plug-in confirms the signature of the catalog, the latest version of the catalog, and the certification of the payee to certify the validity of the catalog. If the payer want to buy other goods in addition, the payer may take other catalog to pay for the goods. It means that the electronic settlement payment plug-in has a function of a shopping basket. If the catalog is valid, the electronic settlement payment plug-in asks the payer A to buy the goods. In case that the payer A wants to buy the goods, the payer inputs an address to which the goods are to be delivered, and selects a button of progress. The electronic settlement payment plug-in establishes a safe communication channel to a bank, and a secure sockets layer (SSL) protocol may be used. If the electronic settlement payment plug-in successively connects to the bank, the electronic settlement payment plug-in sends to the bank the following information to use the account of the payer A.

(a certification of the payer A, (i.e., account number of the payer A): a personal key of the payer A): a public key of the bank

notation : (text): coding the text in a key-key manner

The bank certifies the identity of the payer A by decoding the information, and if nothing is matter, it allocates a business number and sends the business number to the payer A. The electronic settlement payment plug-in sends to the bank the order information. At that time, if the bank declares the effect of transaction, the electronic settlement payment plug-in shows the effect of transaction and stores the data.

The second case is that the user takes an electronic commerce using a public computer with an IC card.

(a certification of the payer A, (i.e., account number of the payer A): a personal key of the payer A): a public key of the bank): password of the IC card

If the IC card has no password, anyone can take a business using the IC card. The payer A connects to an electronic commerce site using a web-browser, and brings the catalog of wanted goods. At that time, the payer connects to a catalog file by clicking a button of ‘BUY’ on the homepage, and the web-browser executes automatically an electronic settlement payment plug-in. The electronic settlement payment plug-in confirms the signature of the catalog, the latest version of the catalog, and the certification of the payee to certify the validity of the catalog. If the payer wants to buy other goods in addition, he/she may take other catalogs to pay for the goods. It means that the electronic settlement payment plug-in has a function of a shopping basket. If the catalog is valid, the electronic settlement payment plug-in asks the payer A to buy the goods. In case that the payer A wants to buy the goods, the payer inputs an address to which the goods are to be delivered, and selects a button of progress. The electronic settlement payment plug-in establishes a safe communication channel to a bank, and a secure sockets layer protocol may be used. The electronic settlement payment plug-in inquires the payer A of the password to use the IC card. At that time, if the payer A inputs the password, the information (a certification of the payer A, (i.e., account number of the payer A): a personal key of the payer A): a public key of the bank) is decoded to be transferred to the bank. The electronic settlement payment plug-in codes the information and sends to the bank. At that time, if the password is wrong, the information (a certification of the payer A, (i.e., account number of the payer A): a personal key of the payer A): a public key of the bank) is not outputted properly, thereby not solving it by the personal key of the bank. Accordingly, the certification of the identity fails. If the password is correct, the bank conceives the information of the payer A. Accordingly, it is possible to use the public computer without inputting the personal information. The bank certifies the identity of the payer A by decoding the information, and if nothing is matter, it allocates a business number and sends the business number to the payer A. The electronic settlement payment plug-in sends to the bank the order information. At that time, if the bank declares the effect of transaction, the electronic settlement payment plug-in shows the effect of transaction and stores the data.

The third case is that the user buys goods in a store using an IC card. At that time, since the catalog is saved in a computer of the store, it is unnecessary to bring the catalog. The payer A confirms the catalog of the wanted goods on the computer of the store. At that time, a program for settlement is executed. If the contents of the catalog are normal, the payer inputs his address and selects a ‘BUY’. The program requests the payer A to insert the IC card. If the IC card is inserted, the program establishes a safe communication channel to a bank. The program inquires the payer A of the password to use the IC card. At that time, if the payer A inputs the password, the information (a certification of the payer A, (i.e., account number of the payer A): a personal key of the payer A): a password of the IC card) is decoded to be transferred to the bank. The electronic settlement payment plug-in codes the information and sends to the bank. At that time, if the password is wrong, (a certification of the payer A, (i.e., the account number of the payer A): a personal key of the payer A): a public key of the bank) is not outputted properly, thereby not solving it by the personal key of the bank. Accordingly, the certification of the identity fails. If the password is correct, the bank conceives the information of the payer A. Accordingly, it is possible to use the public computer without inputting the personal information. The bank certifies the identity of the payer A by decoding the information, and if nothing is matter, allocates a business number and sends the business number to the payer A. The electronic settlement payment plug-in sends to the bank order information. At that time, if the bank declares the effect of transaction, the electronic settlement payment plug-in shows the effect of transaction, and the business information is saved in the IC card. An information serving as a check is saved in the computer of the payee (the store).

With the present invention, the payment of the electronic settlement between the payer and the payee is assigned by the payment settlement agency, thereby preventing the problems of the electronic commerce, i.e., the wiretapping, the forgery, and the injustice use by other persons, effectively preventing that the person concerned deny the business, and assuring the security of the business.

In addition, since only the payer knows the business particulars, the anonymity of business is secured. When a crime is happened, the business particulars may be traced by collecting the information of the payee and the payment settlement agency.

Also, since some programs are installed in the existing system, the extension of the system is increased.

According to a 1999 report of Housing & Commercial bank analyzing a cost of electronic transfer, an ATM is 123 won, a tele-banking is 81 won, and a PC banking is 47 won (1 dollar is about 1300 won). A cost of the present invention is nearly same as that of the PC banking. In case that the payment settlement agency collects the currency during any period, the cost may be further lowered.

Since the payment of the electronic settlement between the payer and the payee is assigned by the payment settlement agency, the payer and the payee are provided with a confidence regarding the business effect. In addition, if a problem on the business is happened, it can be settled down based on the information saved in the payment settlement agency.

What is claimed is:

1. A method of paying an electronic settlement in an electronic commerce, the method comprising the steps of:
a first step of a payer obtaining an electronic catalog from the payee through Internet;
a second step of the payer approving an access of a payer's bank account by a payment settlement agency server;
a third step of the payer ordering goods to a payee server and paying a settlement through of the payment settlement agency;
a fourth step of the payment settlement agency server providing confirmation of an effect of transaction between the payer and the payee to concerned parties of the transaction; and
a fifth step of transferring a deposit from the payer's bank account to a payee's bank account through a financial network.

2. The method as claimed in claim 1, wherein the third step includes the steps of:
c-1) the payment settlement agency giving a business number regarding an interest business to the payer
c-2) the payment settlement agency receiving the business number and coded information from the payee, which includes order information, a payment amount, and information on a store;
c-3) sending information with the coded information and information regarding the payment settlement agency being sent to a server of the payee denoted in the coded information; and
c-4) the payee confirming the order of the payer from the information transmitted from the payment settlement agency, coding and executing the information necessary to the business, and sending the information to the payment settlement agency.

3. The method as claimed in claim 2, wherein the fourth step includes the steps of:
the payment settlement agency comparing a price received from the server with a price received from the payer to confirm an exact transfer of the order information; and
after the confirmation, the payment settlement agency certifying and sending to the payer the information, and certifying and sending to the payee the information with the business number and an amount of money to be paid.

4. The method as claimed in claim 1, wherein the catalog includes a classification code of goods, price of goods, business information of a store, connection information of the store, certification of the store, position of up-to-date information, and signature of a seller to determine a validity of the catalog.
